(19) United States
(12) Patent Application Publication
(10) Pub. No.: US 2018/0121757 A1
(43) Pub. Date: May 3, 2018

(54) SYSTEM AND METHOD FOR AUTOMATED OBJECT RECOGNITION

(71) Applicant: TRENDIGURU LLC, Tel Aviv (IL)

(72) Inventors: Jeremy Rutman, Tel Aviv (IL); Lior SABAG, Tel Aviv (IL)

(73) Assignee: Jeremy Rutman, Tel Aviv (IL)

(21) Appl. No.: 15/573,463

(22) PCT Filed: May 12, 2016
(86) PCT No.: PCT/IL2016/050505

§ 371 Date: Nov. 11, 2017

(51) Int. Cl. G06K 9/62

(52) U.S. Cl. CPC G06K 9/6211; G06K 9/6215

(57) ABSTRACT

A system and method for object recognition is presented. The system is based on finding invariant common features in source and target images, projecting these features into a four dimensional space comprised of the x,y coordinates of each feature on source and target image, and detecting the existence (or lack thereof) of a sufficient number of such points on a single hyperplane or hypersurface. The existence of such a hyperplane or surface indicates a match between source and target.

### BACKGROUND

### Technical Field

Embodiments of the present invention relate generally to systems and methods for automated recognition of objects.

### Description of Related Art

Automated object recognition is a rapidly developing field useful for a wide variety of tasks. Algorithmic face recognition for example has recently become feasible on a large scale, facilitating a number of applications hitherto not possible.

However, with increasing degrees of freedom of the object to be recognized comes increased difficulty of successful detection and recognition. Hence, an improved method for automated object recognition is still a long felt need.

### BRIEF SUMMARY

According to an aspect of the present invention, there is provided a system and method for object recognition based on finding invariant common features in source and target images, projecting these features into a four-dimensional space comprised of the x,y coordinates of each feature on source and target image, and detecting the existence (or lack thereof) of a sufficient number of such points on a single hyperplane or hypersurface. The existence of such a hyperplane or surface indicates a match between source and target.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a source, target, and combined image.

FIGS. 2A, 2B illustrate recognition of matching features on two images.

FIG. 3 illustrates a projection of these features into a three-dimensional space, with a fourth dimension indicate by point size.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for automated object recognition.

In the following detailed description, numerous specific details are set forth in order to provide a thorough understanding of embodiments of the present invention. However, those skilled in the art will understand that such embodiments may be practiced without these specific details. Furthermore just as every particular reference may embody particular methods, systems, yet not require such, ultimately such teaching is meant for all expressions notwithstanding the use of particular embodiments. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

The method is based on use of features that are ideally invariant to rotation, scaling, viewpoint change, illumination/contrast change, and continuous local or global nonlinear deformations of various sorts. Features invariant to some or most of these have been found, including the use of various combinations (such as triples) of corners and edges as in the SURF and SIFT algorithms, histogram-of-gradients, steerable filters, differential invariants, moment invariants, complex filters, and cross-correlation of various types of interest points. Automatic methods for finding invariant features have also been developed, such as those using neural nets, support vector machines, and the like.

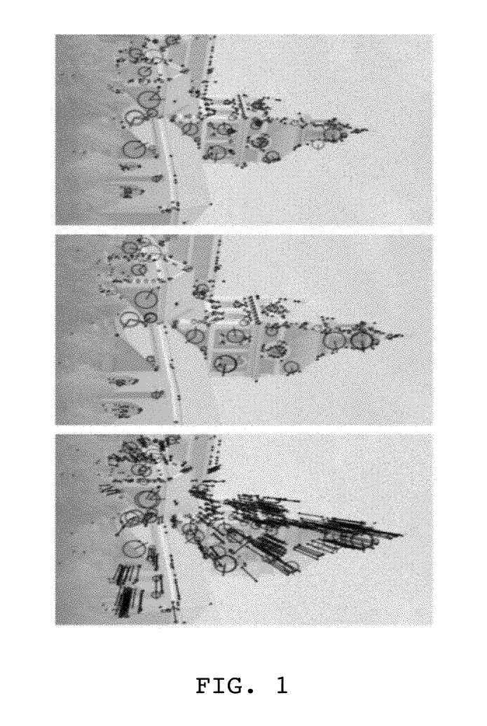

Regardless of the type or types of features chosen, there comes a stage at which a decision must be made as to whether a given target is found in a given source based on feature correspondence. As seen in FIG. 1A-C, the existence of large numbers of corresponding features in roughly the same relative positions should be indicative of a match; the question is, given a tangle of such corresponding points, how does one conclude that a given set is a match or simply due to noise?

In SIFT, the Hough Transform is used to cluster reliable model hypotheses to search for keys that agree upon a particular model pose. The Hough transform identifies clusters of features with the same pose by using each feature to vote for all object poses that are consistent with the feature. Multiple votes increase the probability of the interpretation being correct. The correspondences are searched to identify all clusters of at least 3 entries and are sorted into decreasing order of size.

The similarity transform implied by the 4 linear Hough transform parameters of 2D location, scale, and orientation is only an approximation to the full 6 degree-of-freedom pose space for a 3D object and also does not account for any non-rigid deformations. Various attempts to account for more deformation including allowing broader tolerances for correspondence (e.g. 30 degrees for orientation, a factor of 2 for scale, and 0.25 times the maximum projected training image dimension (using the predicted scale) for location).

Models are verified by linear least squares. Each identified cluster is then subject to a verification procedure in which a linear least squares solution is performed for the parameters of the affine transformation relating the model to the image.

Outliers can now be removed by checking for agreement between each image feature and the model, given the parameter solution. Given the linear least squares solution, each match is required to agree within a certain error range.

The final decision to accept or reject a model hypothesis is based on a probabilistic model which first computes the expected number of false matches to the model pose, given the projected size of the model, the number of features within the region, and the accuracy of the fit. A Bayesian probability analysis then gives the probability that the object is present based on the actual number of matching features found. Lowe's SIFT based object recognition gives excellent results except under wide illumination variations and under non-rigid transformations.

“Speeded Up Robust Features” or SURF is a high-performance scale and rotation-invariant interest point detector/descriptor claimed to approximate or even outperform previously proposed schemes with respect to repeatability, distinctiveness, and robustness. SURF relies on integral images for image convolutions to reduce computation time, and uses a fast Hessian matrix-based measure for the detector and a distribution-based descriptor. It describes a distribution of Haar wavelet responses within the interest point neighbourhood. Integral images are used for speed and only 64 dimensions are used reducing the time for feature computation and matching. The indexing step is based on the sign of the Laplacian, which increases the matching speed and the robustness of the descriptor.

In contrast to such approaches, the current invention simply takes the 2D coordinates of matching feature pairs. This yields four parameters which are taken to represent a single point in four-dimensional space. Multiple matching feature pairs will give multiple points in this 4D space, and the points may now simply be checked to determine whether they are coplanar.

The familiar triple product

a*(b×c)

where a,b,c are vectors formed by any four points in question can be used to determine the volume of the cube having these vectors as edges; if the triple product is zero, the points are coplanar. Similarly the N-dimensional hypervolume of an N-simplex is determined by the determinant of N+1 points

$${V}_{N} = \frac{1}{N !} det [ \begin{matrix}{x}_{1} & {x}_{2} & … & {x}_{N} & {x}_{0} \\ {y}_{1} & {y}_{2} & … & {y}_{N} & {y}_{0} \\ ⋮ & ⋮ & ⋱ & ⋮ & ⋮ \\ {w}_{1} & {w}_{2} & … & {w}_{N} & {w}_{0} \\ 1 & 1 & … & 1 & 1\end{matrix} ] . \qquad ( 2 )$$

In our case, clusters of five points can be checked for coplanarity. Any time five points are found whose hypervolume is less than a given threshold, they are stored in a list and an attempt is made to add further points to the cluster, accepting the point into the cluster if the hypervolume grows less than some threshold amount. The largest cluster, or the cluster of largest ratio of number of points to volume, is chosen.

It will be appreciated by one skilled in the art that even in the case of local or global nonlinear deformation, the hypervolume as above will still be less than some threshold and can therefore still be used to determine image similarity. An alternate method is to use clusters of nearest neighbors or within neighborhoods for hypervolume determination, allowing for deformation of image parts while requiring local areas to remain similar.

An alternative method fits the matching points to surfaces of arbitrary polynomial (for instance) degree. Lower degrees are for instance filtered before higher degrees are considered to keep the solutions as simple as possible, with some maximum degree specified to prevent overfititing.

As will be evident to one skilled in the art, the four-dimensional space considered can be expanded to six or higher dimensions, to allow for relative scaling, rotation, and other transformations of the individual features. The same techniques of N-dimensional volume calculation can be used to threshold candidate points, or alternatively fitting to higher-dimensional surfaces can be employed.

A rough outline of one possible embodiment of the algorithm is given here:
a. determining features on each image;
b. determining pairs of matching features;
c. projecting each such matching feature pair into a 6-dimensional space, the N dimensions being the x,y coordinates of the features, the relative rotation of the features, and the relative scale of features;
d. determine the degree of coplanarity of clusters of matching feature pairs;
e. determining maximal clusters of coplanar matching feature pairs, by adding accepting trial points into the cluster if they add less than some threshold to the cluster volume;
f. determining image similarity by use of said maximal clusters, for example by means of a threshold on volume to number of points, goodness of fit to a surface, or similar measure.

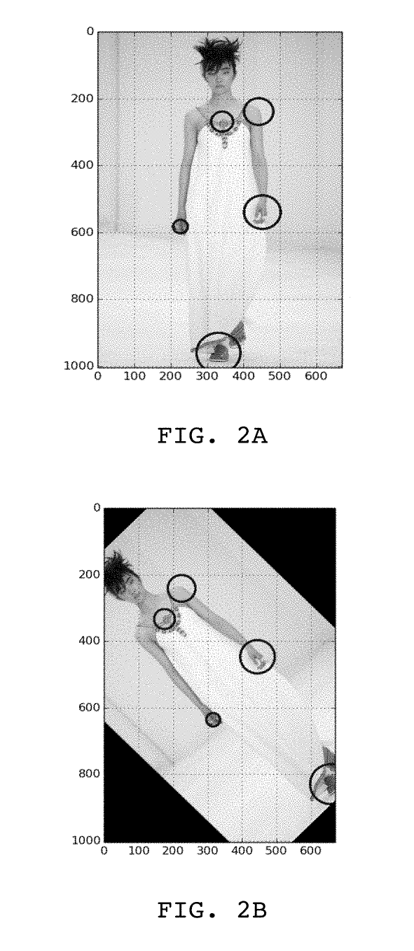

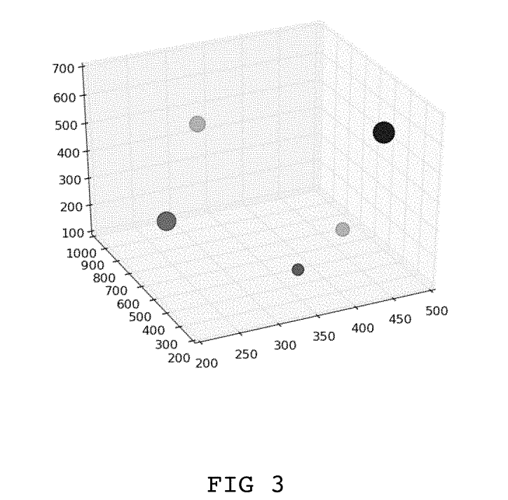

An example of the method at work is shown in FIGS. 2A, 2B, and 3. Here a set of image features are circled in FIG. 2A. These same features are recognized in FIG. 2B, which has a matching image that has undergone some transformation. In the example the transformation is an affine (linear) transformation but this is not a strict requirement for the success of the method. The (x,y) coordinates on the first image (the circle centers of FIG. 2A) are used for the x,y, coordinates of the 3D plot of FIG. 3, while the x-coordinate of the transformed image (FIG. 2B) is used for the z-coordinate in FIG. 3 and the y-coordinate of the transformed image (FIG. 2B) is used to determine the disk size of FIG. 3. In this way we represent four coordinates (x1,y1,x2,y2) in a 3d plot using (x,y,z,disk size). If the set of points in the 3d plot lie on a hyperplane (which in this case would be appear as a 2d plane with uniform change in disk size) then the images correspond and moreover are related through an affine transform; if the points lie on a surface, some other nonlinear transform is at play; and if the points do not form any discernable surface, it is likely that the images do not correspond at all.

A possible method for determining the degree of coplanarity of clusters of matching feature pairs can be implemented by ensuring that the piecewise second order partial derivatives of neighboring points is below a certain threshold, thus guaranteeing “local smoothness” and rejecting impossible transformations of matching features between images.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A method for determination of similarity between a first image and a second image pairs consisting of the steps:
a. determining a set of features on each image;
b. determining matching features from said sets that are common to both images;
c. plotting each such matching feature pair as a 4-dimensional point comprising the x,y coordinates of said features in said first image and the x,y coordinates of said features in said second image;
d. determining the smoothness of a surface fitting said 4-D points;
e. determining a measure of correspondence depending upon said smoothness and the number of said matching features
whereby a measure of image correspondence is determined even for images that have undergone nonlinear transformations.

2. The method of claim 1 wherein said features are determined by methods selected from the group consisting of: Harris corner detector, Harris-Laplace, Multi-Scale Oriented Patches, LoG filter, FAST, BRISK, ORB, KAZE, A-KAZE, Wavelet filtered image patch, Histogram of oriented gradients, GLOH, LESH, BRISK, ORB, FREAK, LDB, and neural network-determined features.
